(19) United States
(12) Patent Application Publication
(10) Pub. No.: US 2014/0007793 A1
(43) Pub. Date: Jan. 9, 2014

(54) DEVICE FOR TREATING A LIQUID AND METHOD OF TREATING A SUSPENSION

(71) Applicants: Joerg Grau, Baar/Schwaben (DE); Carmelo Oliveri, Ulm (DE)

(72) Inventors: Joerg Grau, Baar/Schwaben (DE); Carmelo Oliveri, Ulm (DE)

(21) Appl. No.: 13/877,414

(22) PCT Filed: Oct. 7, 2011
(86) PCT No.: PCT/EP2011/005022

§ 371 Date: Jun. 12, 2013

(30) Foreign Application Priority Data
Oct. 8, 2010 (DE) 10 2010 047 947.0

(51) Int. Cl. B01F 3/04; B01J 19/00

(52) U.S. Cl. CPC B01F 3/0446; B01J 19/008; B01F 3/04439
USPC 106/287.35; 261/93; 366/279; 210/758; 261/74

(57) ABSTRACT

A device for treating a liquid has a chamber and a rotatable cavitation element arranged within the chamber. According to a first aspect, the chamber has a cross-section with different roundnesses in the region of the cavitation element. According to a second aspect, the substantially disk-shaped cavitation element has (preferably oblong) passage openings which have rounded inner walls.

The invention relates to a device for treating a liquid. More particularly, the invention relates to a device and a method for treating a suspension.

Charging a liquid with gas is of advantage for a multitude of purposes. For example, it allows chemical reactions to occur between the gas and the liquid or between the gas and substances contained in the liquid. One possible purpose of use is the treatment of water, both of drinking water and of wastewater, where the introduction of appropriately reactive gases can reduce the germ load.

WO 2008/080618 A1 discloses a device for treating a liquid, including a mechanical cavitation element arranged in a chamber, and a gas supply means which extends through the cavitation element. The device further includes an acoustic power transducer which emits sound waves directly into the chamber. The movements of the cavitation element make sure that the gas supplied is mixed with the liquid to be treated, in which the mean bubble size is still relatively large. As a second measure, sound waves are introduced directly into the liquid at the same time by the acoustic power transducer, as a result of which the mean bubble size is further reduced throughout the liquid. When the known device and the known method are made use of to obtain a sonochemical dissolution of the gas in the liquid in which a major proportion of the gas is present in a molecularly dispersively dissolved form, the power transducer is required to be in the form of an ultrasonic transducer that supplies frequencies in a range between 400 and 1500 kHz, preferably between 600 and 1200 kHz.

The object of the invention is to even more increase the efficiency of charging a liquid with gas.

This object is achieved by a device having the features of claim 1 and by a device having the features of claim 7. Advantageous and expedient further developments of the device according to the invention are indicated in the dependent claims.

According to a first aspect, the device according to the invention for treating a liquid includes a chamber and a rotatable cavitation element, in particular in the form of a flow body, arranged within the chamber. The chamber has a cross-section with different roundnesses in the region of the cavitation element.

This aspect of the invention is based on the finding that a cross-section with different roundnesses, on the one hand, counteracts an undesirable rotational flow of the liquid about the axis of rotation of the cavitation element and, on the other hand, prevents “dead” chamber corners in which only a small amount of liquid exchange occurs. Rather, the cross-sectional shape of the chamber according to the invention assists the formation of local swirls with high flow velocities, which considerably increases the cavitation effect.

Preferably, the cross-section of the chamber has a basic shape of a polygon with rounded corners. The rounded corners effectively prevent liquid from accumulating in the corners.

To avoid any “quiet bays” in the chamber, the sides of the polygonal basic shape are preferably convex.

Generally, the chamber is advantageously designed such that the basic shape of the cross-section of the chamber is that of a regular polygon.

A chamber with a cross-section that has a trilobular shape has turned out to be especially advantageous. Such a shape noticeably departs form a circular shape, which would promote an undesirable rotational flow, but still includes wall sections that extend approximately tangentially to a generally circular disk-shaped cavitation element.

Basically, however, the chamber may advantageously also have cross-sections the basic shape of which is that of an irregular polygon.

According to a second aspect, the device according to the invention for treating a liquid includes a chamber and a substantially disk-shaped cavitation element arranged within the chamber. The cavitation element has (preferably oblong) passage openings which have rounded inner walls.

This aspect of the invention is based on the finding that when the cavitation element rotates fast, such a shape of the passage openings allows an optimum acceleration of the liquid without an undesirable splitting up of the liquid occurring.

In a preferred embodiment of the invention, the passage openings each extend from an upper side completely through the cavitation element to a lower side. This basically allows a limited passage of the liquid through the cavitation element.

A preferred design of the passage openings provides that the diameter of the passage openings varies by less than 50%, preferably by less than 30%, further preferably by less than 20%, over the axial height thereof. This makes sure that no liquid accumulates in the passage openings.

According to a particularly preferred design of the passage openings, the inner walls are rounded to different degrees in regions near the upper side and in regions near the lower side. In particular, the rounded portions may be adjusted to the shape of the cavitation element such that an overall flow behavior is obtained that is favorable for the intended pressure fluctuations.

The passage openings may have an oblong edge like an elongated hole on each of the upper side and the lower side.

Another preferred embodiment makes provision that, in a top view, the edge of the passage opening on the upper side is not congruent with the associated edge of the passage opening on the lower side.

In particular, the extent of the edge on the upper side may differ in size from, and/or be offset in relation to, the edge on the lower side in the longitudinal direction of the passage opening.

In combination with the rounded portions, the cavitation effect may be further optimized by an arrangement of the passage openings in which the center of each passage opening is offset relative to the point of intersection of its central longitudinal axis with a radius of the cavitation element perpendicular to this axis in the direction of the central longitudinal axis.

For the treatment of water, particularly of drinking water, a device is of advantage in which the chamber is arranged in a housing made from plastic. In comparison with a metal housing, a plastic housing offers the advantage that it is better to clean and is not attacked by disinfectants. An addition of electrolytes to the liquid is also possible without any problems.

In particular in combination with a trilobular cross-section of the chamber into which an inlet and an outlet for the liquid open, an arrangement is favorable in which the inlet and the outlet are arranged at an angle of less than 180 degrees, preferably at an angle of about 120 degrees, in relation to each other in a radial direction.

In respect of the supply of a gas into the liquid, a gas supply pipe is preferred which has a mouth directed axially on an upper side of the cavitation element, preferably near the axis of rotation of the cavitation element.

In particular, the gas supply pipe may extend at least in sections parallel to a drive shaft on which the cavitation element is arranged.

A cost saving in the realization of the device according to the invention is obtained by the use of at least one acoustic power transducer that is arranged to emit sound waves directly into the chamber, the frequency of the sound waves being below the ultrasonic frequency range. It has turned out that in comparison with the device known from the prior art as initially mentioned, a lower power of the acoustic power transducer is sufficient to achieve a desired bubble size.

Generally, the measures according to the invention allow a very high proportion of gas to be introduced into the liquid. The device according to the invention is therefore highly suitable for the purification of water, in particular of drinking water or wastewater. In particular when ozone is supplied, which can be molecularly dispersely dissolved in the liquid, the device can be made use of for sterilizing the liquid or, generally, for destroying bacteria, viruses, fungal spores, toxins or endocrine disrupting substances, or for the denaturation of proteins. In addition, the device can be generally used for the charging of liquids, not only of water or wastewater, with any suitable gas.

The invention further relates to a method of treating a suspension, in particular by means of a device according to the invention, characterized by the steps of:

introducing the disperse liquid to be treated into a chamber in which a rotating cavitation element is accommodated;

rotating the cavitation element until cavitation is generated without a treatment of the liquid with ultrasound; and

reducing the size of the particles in the liquid by the cavitation.

The method according to the invention operates without acting upon the suspension with ultrasound, but exclusively based on the mechanically acting cavitation element. At the surface of this cavitation element the small cavities form in the liquid, which implode. Due to this imploding process, the solid particles that are present in the liquid are further reduced in size. This means that the reduction in size of the particles is not (only) effected by the particles impinging on the cavitation element, but by the energy released during the numerous implosions at the surface of the cavitation element.

When gas is introduced into the suspension and is also dissolved in the suspension by the cavitation generated without ultrasound, the cavitation is reduced at the same time. The dissolution of gas in the liquid phase may have advantages for the suspension and may produce desirable chemical effects, where appropriate. One example thereof is wastewater treatment.

The method according to the invention will provide special advantages in the production of liquid paint, in particular of a lacquer, since the paint pigments are dispersed particularly finely here. The method can further be employed to advantage in the treatment of paper coating suspensions (e.g. whiting), and in the treatment of wastewater. With respect to the wastewater treatment, it should be added that germs are especially persistent in the shade of solid particles in wastewater. A treatment with UV light should therefore only be regarded as a supporting measure. If, however, the solid particles are still further reduced in size, as taught by the invention, the germ treatment is considerably more effective. The simultaneous dissolution of gas into the liquid may be made use of for germ killing.

Further features and advantages of the invention will be apparent from the description below and from the accompanying drawings, to which reference is made. In the drawings:

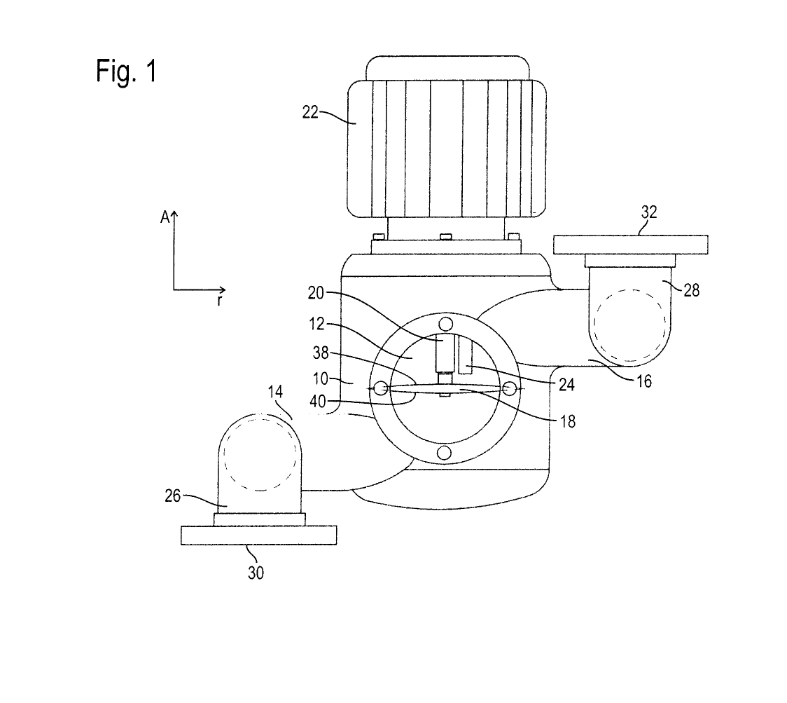

FIG. 1 shows a side view of a device according to the invention for carrying out the method according to the invention;

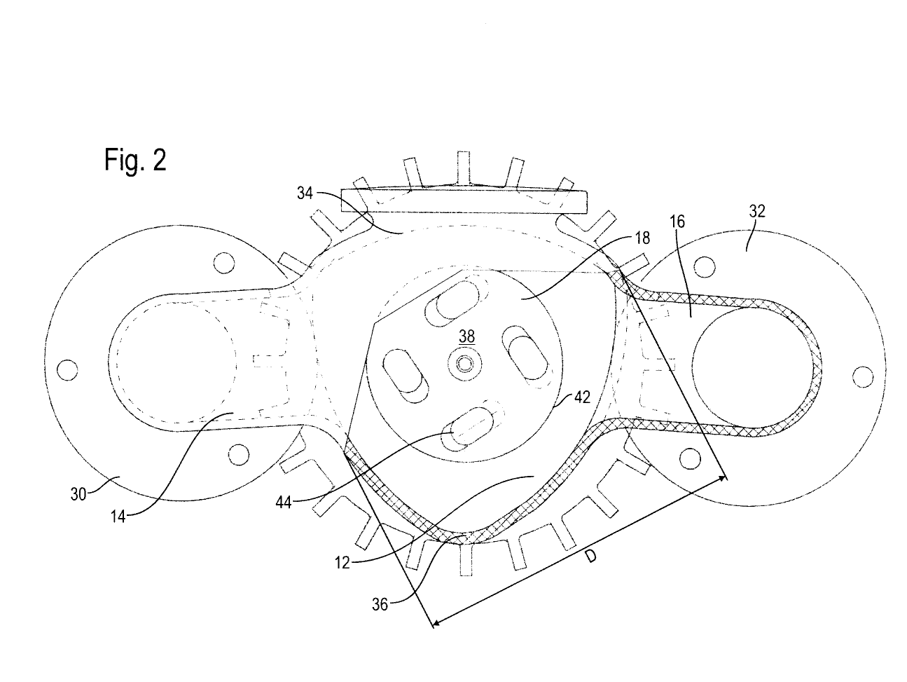

FIG. 2 shows a partially sectioned top view of the device in FIG. 1;

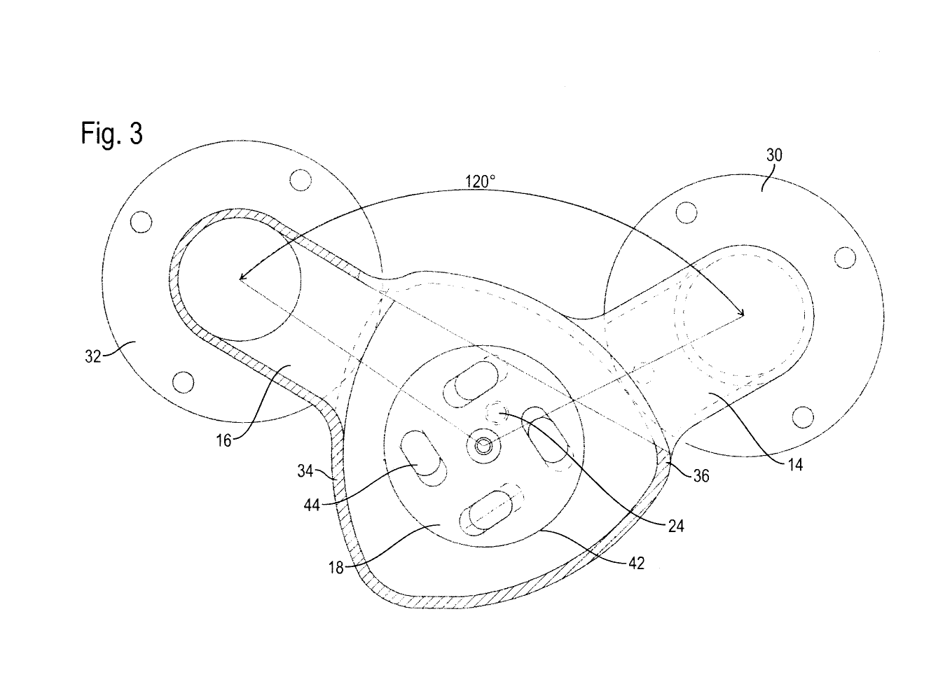

FIG. 3 shows a partially sectioned top view of a device according to the invention in accordance with an alternative embodiment which can also be used for carrying out the method according to the invention;

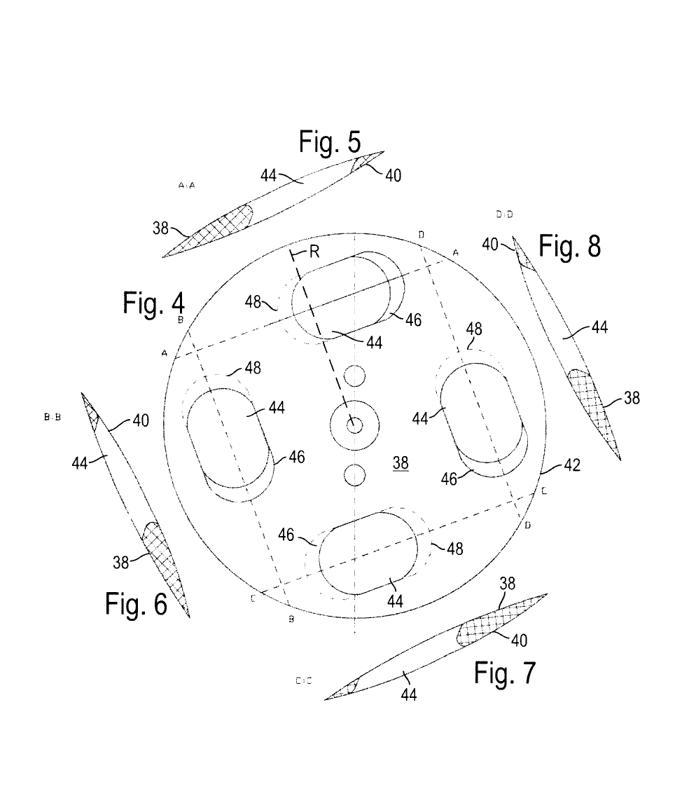

FIG. 4 shows a top view of a mechanical cavitation element of a device according to the invention;

FIG. 5 shows a sectional view taken along section line A-A in FIG. 4;

FIG. 6 shows a sectional view taken along section line B-B in FIG. 4;

FIG. 7 shows a sectional view taken along section line C-C in FIG. 4; and

FIG. 8 shows a sectional view taken along section line D-D in FIG. 4.

FIGS. 1 and 2 show a device according to the invention for the treatment of a liquid by charging the liquid with gas. In the description below, indications such as upper, lower, etc. are used for ease of understanding. These indications relate to an orientation of the device as illustrated in FIG. 1. But the device may basically also be operated when placed on a side.

The basic structure and the basic mode of operation of such a device are known to a person skilled in the art, in particular from WO 2008/080618 A1, so that only the special features of the device according to the invention will be primarily discussed here.

A chamber 12 for receiving a liquid is provided in a housing 10 of the device; the housing may be formed of metal or plastic. An inlet 14 and an outlet 16 open into the chamber 12, so that the liquid can continuously flow through the chamber 12. In the axial direction A, the inlet 14 and the outlet 16 are arranged to be offset in relation to each other; in the radial direction r, they are arranged to be diametrically opposed (angle of 180 degrees).

FIG. 3 shows an alternative embodiment of the device in which the inlet 14 and the outlet 16 are arranged at an angle of 120 degrees relative to each other.

Arranged centrally within the chamber 12 is a mechanical cavitation element 18 which is mounted for rotation and is in the form of a substantially discus-shaped flow body. The cavitation element 18 is connected by means of a drive shaft 20 to a continuously controllable motor 22, which determines the rotational speed of the cavitation element 18.

A gas supply pipe 24 which is part of a gas supply means connected to a gas supply is arranged next to the drive shaft 20 and opens parallel thereto into the chamber 12. The mouth of the gas supply pipe 24 is directed axially onto the upper side of the cavitation element 18.

Two short connecting pieces 26, 28 which are bent by 90 degrees and each have an acoustic power transducer 30, 32 connected thereto are arranged on the inlet 14 and on the outlet 16, which extend in the radial direction. Both acoustic power transducers 30, 32 are in the form of sound generators that operate in the ultrasonic range or preferably in a lower frequency range.

As is apparent from FIGS. 2 and 3, in both embodiments the chamber 12 has a special shape. The chamber 12 has a non-rotationally symmetrical cross-section departing from the circular shape (radial section perpendicular to the axial direction A) in the region of the cavitation element 18 (corresponding to that part of the chamber 12 which surrounds the cavitation element 18).

In the illustrated embodiments, the cross-section of the chamber 12 has a trilobular shape, which may also be referred to as a “rounded triangle”. Unlike in a true triangle, the corners are rounded (small roundness 34) and the sides are curved outward (large roundness 36). The trilobular shape is characterized in that, despite the triangularly oriented basic shape, the rolling diameter D always remains the same since a large roundness 34 and a small roundness 36 are always directly opposite each other.

Rather than the triangular basic shape, provision may also be made for a basic shape with more than three corners (in particular with four or five corners), in which the corners are rounded and the sides are curved outward (convex). Other, irregular, basic shapes having differently heavily pronounced roundnesses are also possible. The triangular basic shape, however, offers the greatest departure from a circular shape, with the curvatures being comparable, which is desirable with a view to the cavitation effect, as will be discussed further below.

In FIG. 4 the cavitation element 18 arranged for rotation in the chamber 12 is illustrated separately. The cavitation element 18 has substantially the shape of a discus (lenticular disk) with opposed convex sides 38, 40 that meet at a sharp, circular peripheral edge 42. The curvatures of the two sides 38, 40 may differ from one another.

The cavitation element 18 has a plurality of passage openings 44 which extend from the upper side 38 completely through the cavitation element 18 to the lower side 40. The passage openings 44 have an oblong edge 46 and 48 like an elongated hole on the upper side 38 and the lower side 40, respectively. In a top view, however, the edges 46 of the upper side 38 are not congruent with the associated edges 48 of the lower side; in particular, the extent in the longitudinal direction of the upper side and lower side edges 46 and 48, respectively, differs in size and/or is offset. Accordingly, the periphery of the upper side edges 46 may be larger or smaller than or of the same size as the associated lower side edges 48.

As is apparent from the sectional views of FIGS. 5 to 8, the inner walls of the passage openings 44 are not straight, but rounded. This means, for one thing, that the inner walls have a curved profile and, for another thing, that, apart from the edges 46, 48, they have no edges or corners. In some cases, the rounding, at least in sections, is more pronounced in the regions near the upper side 38 than in the regions near the lower side; in some cases it is the other way round.

Further, it is characteristic of the passage openings 44 that the diameter thereof, in spite of the rounded portions, varies by less than 50% and preferably by less than 30% over the axial height. In the exemplary embodiment illustrated, the diameter varies by distinctly less than 20%.

In addition, each passage opening 44 is arranged such that its center is offset relative to the point of intersection of its central longitudinal axis (section lines A-A, B-B, C-C and D-D, respectively) with a radius R of the cavitation element 18 perpendicular to this axis in the direction of the central longitudinal axis.

For charging a liquid with gas when using the device, the liquid flows through the chamber 12 in such a manner that the latter is preferably completely filled with liquid. The motor 22 causes the cavitation element 18, which is totally immersed in the liquid, to rotate so fast that cavitation occurs in the liquid.

In this connection, the special shape of the chamber 12 having the trilobular cross-section (or a similar cross-section as described above) and the special shape of the cavitation element 18 provide for an increase in the cavitation effect.

Owing to the cross-sectional shape of the chamber 12 having the different roundnesses 34, 36, the rotation of the cavitation element 18 does not cause the liquid to move entirely in an undesirable rotating circular flow, which would not be conducive to the cavitation effect. But no “dead” points in which only a small amount of liquid exchange takes place will form in the corners of the chamber 12 since the corners are not sharp, but rounded. The shape of the chamber 12 also makes sure that as few standing waves as possible will develop in the chamber 12.

Based on the rounded passage openings 44 in the cavitation element 18, very high flow velocities develop not only in the region of the peripheral edge of the cavitation element 18, but also in the regions of the passage openings 44, as a result of which a very high cavitation effect results at these very points. But the passage openings 44 also effectively counteract any undesirable splitting up of the liquid, particularly at high speeds of the cavitation element 18.

Due to the special shape of the chamber cross-section with the different roundnesses 34, 36 and the special shape of the passage openings 44 of the cavitation element 18, an undesirable pump action of the cavitation element 18 on the liquid is generally avoided.

Gas is conducted through the gas supply line 24 in the axial direction A onto the upper side of the cavitation element 18. The gas may also be fed into the system in liquid form, e.g. in the form of liquid oxygen; when it passes through the gas supply line 24, the gas is preferably already present in a gaseous condition.

Based on the high cavitation effect, the gas introduced is virtually completely incorporated into the liquid. The amount of gas introduced may, for example, amount to 285 g/h for oxygen in well water having a temperature of 15° C.

The entire chamber 12 is filled by the sound waves of the acoustic power transducers 30, 32 at the same time, so that the bubbles generated by the cavitation element 18 are immediately further worked on by the sound energy and are reduced in size in the process.

Altogether the cavitation with the aid of the specially shaped cavitation element 18 within the specially shaped chamber 12 and the additional sound treatment of the generated bubbles in a comparatively low frequency range result in a mean bubble size in the nanometer range in an efficient manner, and a large proportion of bubbles in the angstrom range is generated. This results in that a large proportion of the gas introduced is molecularly dispersively dissolved in the liquid. Therefore, the entirety of the incorporated gas will remain in the liquid over a relatively long period of time.

The invention has been described with reference to preferred embodiments. Modifications and supplementations are, of course, possible at the discretion of a person skilled in the art, without thereby departing from the idea of the invention.

The previously mentioned device allows suspensions to be treated very effectively in that the microparticles present therein can be further reduced in size. The method provides for the following steps: introducing the disperse liquid to be treated into the chamber 12 in which the rotatable cavitation element 18 is accommodated; rotating the cavitation element 18 up to generation of cavitation without the treatment of the liquid with ultrasound; and reducing the size of the particles in the liquid by the cavitation. In this method, no additional ultrasound treatment is performed in the chamber 12. The suspension is also not treated with ultrasound prior to introducing it into or after removing it from the chamber 12.

The method operates without an exposure of the suspension to ultrasound, but exclusively with the mechanically acting cavitation element 18. The small cavities in the liquid, which implode, form at the surface of this cavitation element 18. Due to these implosions, the solid particles that are present in the liquid are further reduced in size.

Alternatively, gas may be additionally introduced into the suspension and also be dissolved in the suspension by the cavitation generated in an ultrasound-free manner. The dissolution of gas in the liquid phase may have advantages for the suspension and may bring about desirable chemical effects, if appropriate. One example thereof is wastewater treatment.

The method may be employed in the production of liquid paint, in particular of a lacquer, since here the paint pigments are particularly finely dispersed.

Further, the method is advantageously employed in the production of paper. In the method provision is made for the solid particles in paper coating suspensions (e.g. whiting) to be dispersed especially well in the liquid and to be reduced in size. The suspensions treated in this manner are applied onto the paper web with a doctor blade and provide for a smooth paper surface.

In the treatment of wastewater, the solid particles are still further reduced in size when the method is used, so that the germ treatment becomes considerably more effective. The simultaneous dissolution of gas into the liquid may be made use of for germ killing.

### LIST OF REFERENCE NUMBERS

10 housing

12 chamber

14 inlet

16 outlet

18 cavitation element

20 drive shaft

22 motor

24 gas supply pipe

26 first connecting piece

28 second connecting piece

30 first acoustic power transducer

32 second acoustic power transducer

34 large roundness

36 small roundness

38 upper side of cavitation element

40 lower side of cavitation element

42 peripheral edge

44 passage openings

46 upper side edges

48 lower side edges

1. A device for treating a liquid, the device comprising
a chamber, and
a rotatable cavitation element arranged within the chamber,
wherein the chamber has a cross-section with different roundnesses in the region of the cavitation element.

2. The device according to claim 1, wherein the cross-section of the chamber has a basic shape of a polygon with rounded corners.

3. The device according to claim 2, wherein the sides of the polygonal basic shape are convex.

4. The device according to claim 2, wherein the basic shape of the cross-section is that of a regular polygon.

5. The device according to claim 4, wherein the cross-section of the chamber has a trilobular shape.

6. The device according to claim 1, wherein the basic shape of the cross-section is that of an irregular polygon.

7. A device for treating a liquid, comprising
a chamber, and
a substantially disk-shaped cavitation element arranged within the chamber,
wherein the cavitation element has passage openings which have rounded inner walls.

8. The device according to claim 7, wherein the passage openings each extend from an upper side completely through the cavitation element to a lower side.

9. The device according to claim 8, wherein the diameter of the passage openings varies by less than 50%, preferably by less than 30%, further preferably by less than 20%, over the axial height thereof.

10. The device according to claim 8, wherein the inner walls are rounded to different degrees in regions near the upper side and in regions near the lower side.

11. The device according to claim 8, wherein the passage openings have an oblong edge like an elongated hole on each of the upper side and the lower side.

12. The device according to claim 8, wherein, in a top view, the edge of the passage opening on the upper side is not congruent with the associated edge of the passage opening on the lower side.

13. The device according to claim 12, wherein the extent of the edge on the upper side differs in size from, and/or is offset in relation to, the edge on the lower side in the longitudinal direction of the passage opening.

14. The device according to claim 7, wherein each of the passage openings is arranged such that its center is offset relative to the point of intersection of its central longitudinal axis with a radius R of the cavitation element perpendicular to this axis in the direction of the central longitudinal axis.

15. The device according to claim 7, wherein the chamber is arranged in a housing made from plastic.

16. The device according to claim 7, wherein an inlet and an outlet open into the chamber which are arranged at an angle of less than 180 degrees, preferably at an angle of about 120 degrees, in relation to each other in a radial direction r.

17. The device according to claim 7, further comprising a gas supply pipe having a mouth directed axially on an upper side of the cavitation element, preferably near the axis of rotation of the cavitation element.

18. The device according to claim 17, wherein the gas supply pipe extends at least in sections parallel to a drive shaft on which the cavitation element is arranged.

19. The device according to claim 7, further comprising at least one acoustic power transducer that is arranged to emit sound waves directly into the chamber, the frequency of the sound waves being below the ultrasonic frequency range.

20. A method of treating a suspension comprising the steps of:
a) introducing the disperse liquid to be treated into a chamber in which a rotating cavitation element is accommodated;
b) rotating the cavitation element until cavitation is generated without a treatment of the liquid with ultrasound; and
c) reducing the size of the particles in the liquid by the cavitation.

21. The method according to claim 20, wherein gas is introduced into the suspension and dissolved in the suspension by the cavitation generated in an ultrasound-free manner.

22. The method according to claim 20, wherein the method is a method of producing liquid paint, in particular a lacquer, a method of treating a whiting for paper surface coating, or a method of treating wastewater.

23. The device according to claim 7, wherein the passage openings are oblong.

24. The device according to claim 1, wherein the chamber is arranged in a housing made from plastic.

25. The device according to claim 1, wherein an inlet and an outlet open into the chamber which are arranged at an angle of less than 180 degrees, preferably at an angle of about 120 degrees, in relation to each other in a radial direction r.

26. The device according to claim 1, further comprising a gas supply pipe having a mouth directed axially on an upper side of the cavitation element, preferably near the axis of rotation of the cavitation element.

27. The device according to claim 26, wherein the gas supply pipe extends at least in sections parallel to a drive shaft on which the cavitation element is arranged.

28. The device according to claim 1, further comprising at least one acoustic power transducer that is arranged to emit sound waves directly into the chamber, the frequency of the sound waves being below the ultrasonic frequency range.
